(19) United States
(12) Patent Application Publication
(10) Pub. No.: US 2017/0334227 A1
(43) Pub. Date: Nov. 23, 2017

(54) METHOD AND APPARATUS FOR PRINTING IMAGES ON A TEXTILE SUBSTRATE WITH DYE SUBLIMATION

(71) Applicant: Caretek, Inc., Denver, CO (US)

(72) Inventor: Daniel GREENE, Denver, CO (US)

(21) Appl. No.: 15/499,763

(22) Filed: Apr. 27, 2017

Related U.S. Application Data
(60) Provisional application No. 62/328,238, filed on Apr. 27, 2016.

(51) Int. Cl. B41M 5/035; D06P 5/28; B41M 5/025; B44C 1/175

(52) U.S. Cl. CPC B41M 5/035; D06P 5/004; B41M 5/0256; B44C 1/1756

(57) ABSTRACT

The present disclosure provides an apparatus for transferring an image onto a textile substrate using dye sublimation, the apparatus comprising: a flat support structure on which the textile substrate is laid with an ink transfer substrate; a heating element that rotates and applies heat while pulling the textile substrate and ink transfer substrate from the flat support structure towards the heating element; and a chevron-shaped brush with the vertex of the chevron pointing away from the heating element wherein the textile substrate and ink transfer substrate pass under the chevron-shaped brush before contacting the heat element. Also provided is a method for transferring an image onto a textile substrate using dye sublimation.

### CROSS REFERENCE TO RELATED APPLICATIONS

This application claims priority to U.S. Provisional Application No. 62/328,238 filed Apr. 27, 2016, the contents of which are incorporated herein by reference in their entirety.

### FIELD

The present disclosure relates to an apparatus and method for transferring an image onto a textile substrate using dye sublimation.

### BACKGROUND

Dye sublimation involves first imparting an image or decorative design on a dyestuff (i.e., dye carrier) with sublimation inks. The image or decorative design is typically imparted on the dyestuff by an inkjet or a laser printer. After the image is imparted on the dyestuff, a manufacturer places the dyestuff on the substrate (object on which the image is to be printed). There are a number of different ways that the manufacturer can then sublimate the dye into the given substrate.

Generally, sublimation is a type of ink and/or dye printing that employs heat and pressure to transfer a decoration held on a sublimation-ink support sheet (also known as a transfer or carrier sheet) onto a target product. In the past, various devices have been proposed to carry out the transfer so as to accommodate different object configurations as well as to attempt to improve image reproduction and/or color on the object. Conventionally, an indirect two-step ink support printing process has been used. For example, a target decoration is printed onto a first ink transfer paper, the mirror image of the decoration is transferred to a second ink transfer fabric sheet, then the mirror image of the second sheet decoration is resublimated onto the target product. During the dye-sublimation process, the dye-sublimation ink is converted into a gas that permeates the fabric and solidifies within the fibers. The dye-sublimation inks can be quick-cure ultraviolet inks, solvent-based inks, and water-soluble, screen-printing inks.

During the process of transferring the dyestuff to the substrate, it is important that the dyestuff and substrate be in close contact and no wrinkles or irregularities in the surface of the substrate be present. Otherwise, the irregularities will be reflected in the image transferred to the substrate resulting in a distorted image and low quality product. There is a need for safe, efficient methods of stretching and holding in place a flexible substrate (e.g., a textile) and a carrier sheet during dye sublimation.

### BRIEF DESCRIPTION OF THE DRAWINGS

FIG. 1 depicts an embodiment of the invention where the chevron-shaped brush is resting on the flat support structure. Next to the chevron-shaped brush is shown the heating element used for dye sublimation.

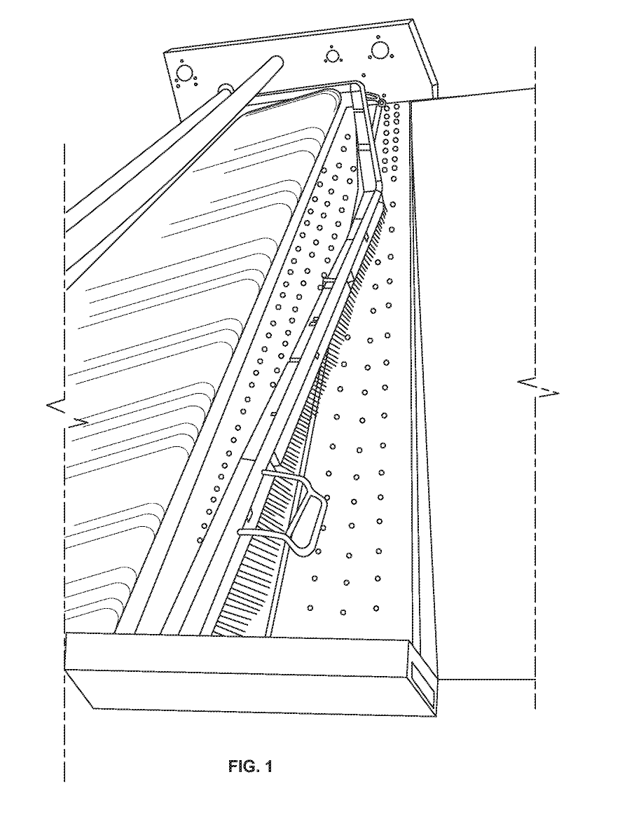

FIG. 2 depicts an embodiment of the invention where the chevron-shaped brush is raised off of the flat support structure. The heating element is shown behind the chevron-shaped brush.

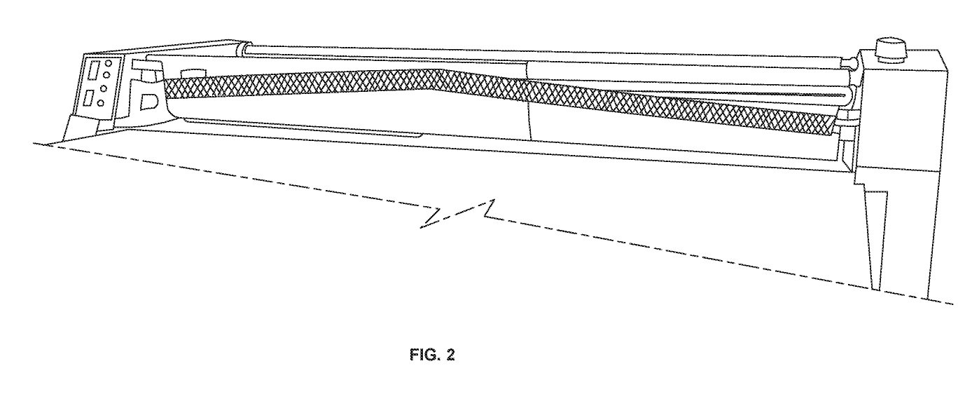

FIG. 3 depicts an alternative view of an embodiment of the invention where the chevron-shaped brush is resting on the flat support structure. The heating element is shown behind the chevron-shaped brush.

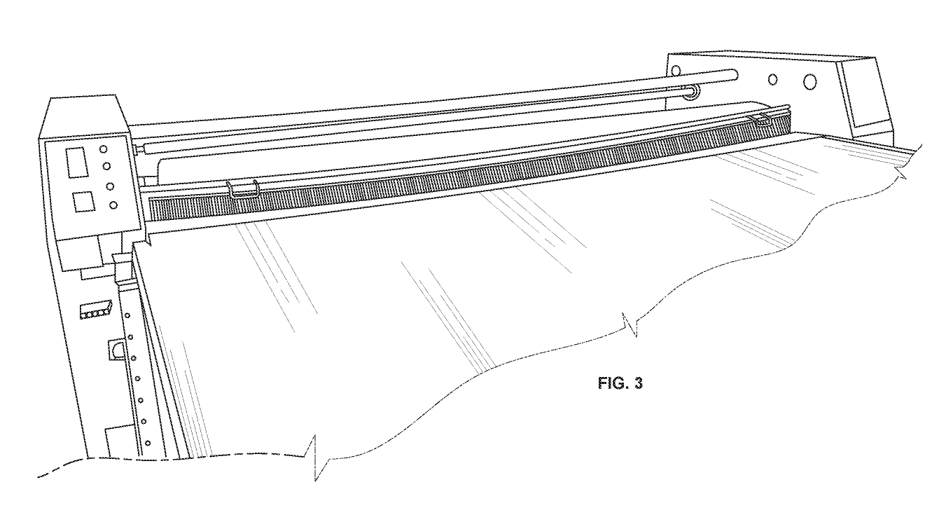

FIG. 4 depicts the ink transfer substrate lying on the flat support structure. A stretch fabric is spread across the ink transfer substrate in preparation for dye sublimation onto the stretch fabric.

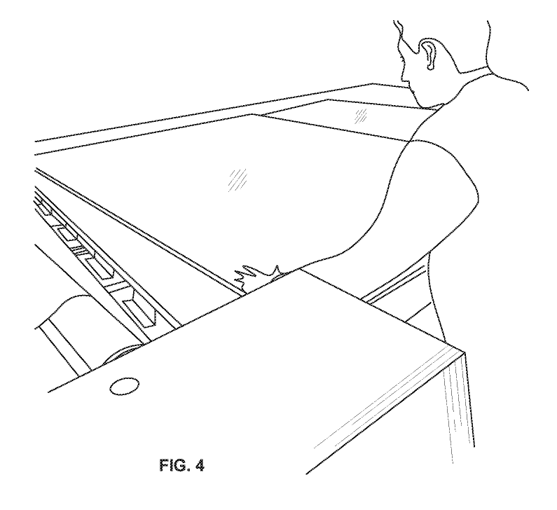

FIG. 5 depicts the stretch fabric and the ink transfer substrate being fed into the apparatus. In one aspect, the chevron-shaped brush spreads the stretch fabric before it reaches the heating element ensuring that no wrinkles in the stretch fabric are present during dye sublimation as shown.

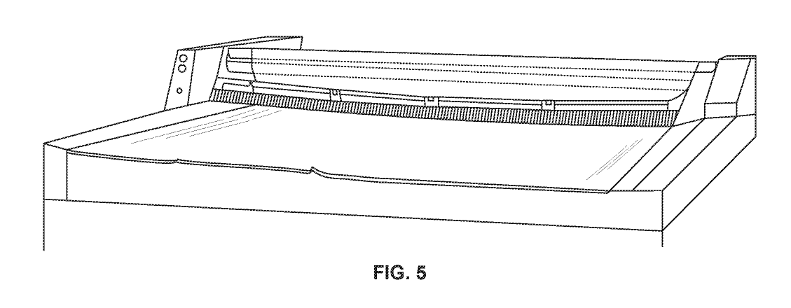

FIG. 6 depicts the stretch fabric and the ink transfer substrate being fed into the apparatus. The point or vertex of the chevron-shaped brush is pointing in the opposite direction to that in which the stretch fabric and ink substrate are moving towards the heating element.

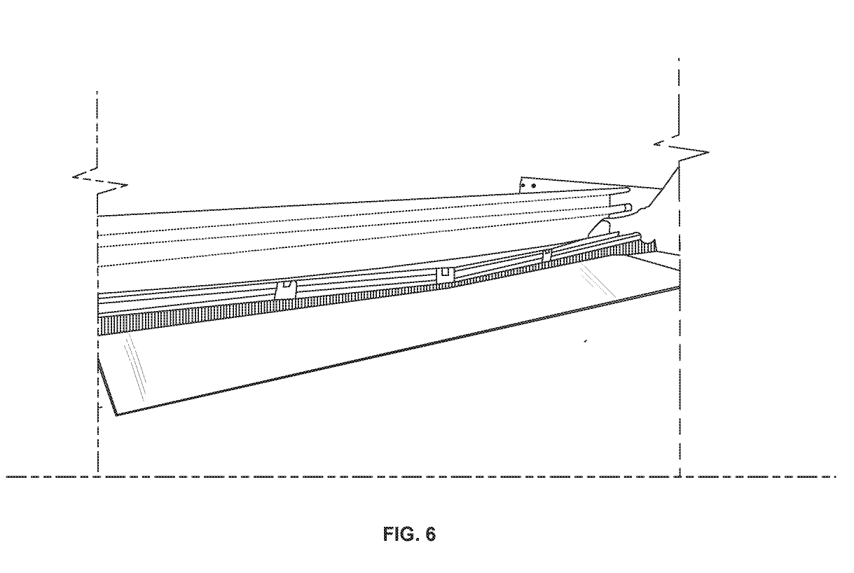

### DETAILED DESCRIPTION

In some embodiments, the present invention is directed to an apparatus for transferring an image onto a textile substrate 102 using dye sublimation, the apparatus comprising: a flat support structure 101 on which the textile substrate 102 is laid with an ink transfer substrate 103; a heating element 104 that rotates and applies heat while pulling the textile substrate 102 and ink transfer substrate 103 from the flat support structure 101 towards the heating element 104; and a chevron-shaped brush 105 with the vertex of the chevron pointing away from the heating element 104 wherein the textile substrate 102 and ink transfer substrate 103 pass under the chevron-shaped brush 105 before contacting the heat element.

In one aspect, the textile substrate 102 is a stretch fabric. In another aspect, the stretch fabric is a material selected from the group consisting of nylon, rayon, cotton, secondary cellulose acetate, wool, silk, polyamides, and combinations thereof.

In certain embodiments, the textile substrate 102 is brushed and/or napped. In other embodiments, the textile substrate 102 is knitted or woven.

In some aspects, the chevron-shaped brush 105 comprises bristles made of a synthetic material that provide the bristles with the flexibility to stretch the textile substrate 102 without tearing or damaging the textile substrate 102. In one embodiment, the synthetic material is selected from the group consisting of a low-density polyethylene (LDPE), a polypropylene, a polyamide (PA), and a polyester.

In some aspects, the PA is selected from the group consisting of PA-6, PA-66, PA-610 and PA-612. In other aspects, the polyester is polybutylene terephthalate (PBT).

In another embodiment, the present invention is directed to a method for transferring an image onto a textile substrate 102 using dye sublimation, the method comprising: a) placing an ink transfer substrate 103 on a flat support structure 101; b) spreading a textile substrate 102 on top of the ink transfer substrate 103; c) feeding the ink transfer substrate 103 and textile substrate 102 under a chevron-shaped brush 105 into a heating element 104 that rotates and applies heat while pulling the textile substrate 102 and ink transfer substrate 103 from the flat support structure 101 towards the heating element 104; and d) applying heat and pressure to the ink transfer substrate 103 and textile substrate 102 with the heating element 104 to induce dye sublimation, wherein the vertex of the chevron points away from the heating element 104 and the textile substrate 102 and ink transfer substrate 103 pass under the chevron-shaped brush 105 before contacting the heat element.

In some aspects, the chevron-shaped brush 105 stretches the textile substrate 102 across the ink transfer substrate 103 to prevent irregularities in the surface of the textile substrate 102 during the dye sublimation. The irregularities may be wrinkles and/or folds in the surface of the textile substrate 102.

As used herein, the verb “comprise” as is used in this description and in the claims and its conjugations are used in its non-limiting sense to mean that items following the word are included, but items not specifically mentioned are not excluded. In addition, reference to an element by the indefinite article “a” or “an” does not exclude the possibility that more than one of the elements are present, unless the context clearly requires that there is one and only one of the elements. The indefinite article “a” or “an” thus usually means “at least one”.

As used herein, the term “ink transfer substrate” refers to a substrate material that carries a sublimation image and/or decoration that is adapted to be sublimated onto a target object. The “ink transfer substrate” can include inks, dyes, and/or other color pigments and/or chemicals thereon that facilitate or define the transferable sublimation decoration.

The term “stretch fabric” includes fabrics that elastically stretch by at least 1%, at least 2%, at least 3%, at least 4%, at least 5%, at least 10%, or at least 15% in at least one direction.

In certain embodiments, an image is printed on an intermediate substrate (e.g., an ink transfer substrate 103) and subsequently transferred. The substrate may be comprised of materials that can be printed upon by an inkjet device, such as a continuous inkjet, drop-on-demand inkjet device such as thermal or bubble inkjet printer, a mechanical or electromechanical digital printing or coating device, or a piezoelectric inkjet printer.

In transfer printing, once the image is printed onto an intermediate substrate, the image may be immediately and permanently transferred onto a final substrate, or the image may be transferred from the intermediate substrate to the final substrate at a later time. The design may be transferred onto a textile substrate 102, such as a shirt, or onto other substrates, such as metal, ceramic, wood, or plastic. A wide selection of preferred final substrates is possible, including, but not limited to, textiles, and especially natural, semi-synthetic or synthetic materials. Examples of natural textile materials include wool, silk, hair and cellulosic materials, particularly cotton, rayon, jute, hemp, flax and linen. Examples of synthetic and semi-synthetic materials include polyamides, polyesters, polyacrylonitriles and polyurethanes. Textile materials may be a blend of natural and synthetic fibers. When transfer printing, a release paper may be used that is coated with a low surface energy material, for example, a silicone polymer or fluorocarbon resin, such as polytetrafluoroethylene, and/or a release agent, such as carboxymethlycellulose. “Release force” describes the required force to remove a layer from the liner/base sheet, and may be subjectively described as ‘easy’ or ‘tight’. The release force may be adjusted by coating formulations and resulting polymer characteristics, or by coat weight. Optimally, the release force is such that it is high (‘tight’) enough such that the ink or toner adheres during and after the fusing step in the printer and any subsequent handling of the printed image, but not so high that the ink or toner is not substantially released from the sheet during transfer to a final substrate (‘easy release’).

In order to prevent premature or undesired reaction of the reactive components, one or more blocking or protecting agents may also be employed. Blocking agents provide protection for the reactants and may be removed or disabled by the application of energy, which may be heat, during the transfer or fixing step of the process

The ink or toner is fixed onto the final substrate by removing protecting agent(s) on the reactive components by the application of energy, such as heat, hot steam, radiation, or pressure, or a combination of these, and allowing reactive species to react with each other and/or chemical groups on the final substrate. For example, the transfer step may be accomplished in this example by the application of heat of at least 100° Celsius, of at least 150° Celsius, of at least 200° Celsius, of at least 250° Celsius, or of at least 300° Celsius. Application of pressure may accompany the application of heat, for at least 1 second, at least 2 seconds, at least 3 seconds, at least 4 seconds, at least 5 seconds, at least 10 seconds, at least 15 seconds, or at least 20 seconds.

In one embodiment, the ink comprises colorants, carriers, humectants, co-solvents, surfactants or emulsifiers. The colorants used in the inks may be dyes or pigments, or a combination of these colorants. Suitable dyestuffs include, but are not limited to pigments, surface modified pigments from chemical grafting, self-dispersing pigments, chemically or physically encapsulated pigments, Acid Dyes, Direct Dyes, Reactive Dyes, Basic Dyes, Solvent Dyes, Disperse Dyes, Reactive Disperse Dyes, Sulphur Dyes, or Vat Dyes, or a combination thereof. These colorants may be used as a single component, or mixed with more than one colorant of the same or different types, along with the rest of the toner or ink ingredients, to enhance the application quality. Pigments and dyes may be incorporated into a flush resin system for easier dispersion within the toner system. Examples of flushed colorants are Sun Phthalo Blue-Green Shade 15 and Sun Diaryl Yellow AAOT 14 (Sun Chemical), and Hostacopy E02-M 101 Magenta (Clariant). The inks may contain from 0-30% colorant. Colored ink will preferably contain between 4-15% colorant by weight.

Disperse colorants, or sublimation colorants, are examples of heat activated dyes that generate vivid and intense color images when printed or dyed onto certain synthetic materials. The translucent nature of the colorants, when activated properly on the synthetic materials, allow the incident radiation to pass partially through the printed substrate, with the colors reflected and diffracted to generate enhanced color depth and esthetic color effects. These colorants should not be materially covered or obstructed by opaque colorants, fabric materials or polymer materials that materially interfere with the reflection of light.

In one embodiment, a reactive ink or toner comprises at least one disperse or sublimation colorant. A transparent or translucent polymeric material is also provided, to which the colorant has an affinity. The polymeric material may be provided in the ink. The ink may be printed on the surface of the substrate, or over an image printed by a first layer of ink that contains a pigment that is either opaque or translucent.

Suitable disperse or sublimation colorants for the process of the present invention include anthraquinone, azo, diazo, quinonline, oxazine, coumarin, xanthene, benzimidazole, diphenylamine, and the like. Specific examples of these colorants include, but are not limited to, disperse yellow 54, disperse yellow 241, disperse yellow 243, disperse orange 1, disperse orange 3, disperse orange 11, disperse orange 155, disperse red 1, disperse red 4, disperse red 11, disperse red 364, disperse red 60, disperse red 91 and 92, disperse red 368, disperse blue 3, disperse blue 14, disperse blue 26, disperse blue 35, disperse blue 56, disperse blue 60, disperse blue 72, disperse blue 79, disperse blue 87, disperse blue 165, disperse blue 183, disperse blue 359, disperse violet 17, disperse violet 33, disperse violet 63, disperse green 6, disperse blue 9, disperse brown 1, disperse brown 9, disperse brown 24 to 27, disperse black 1, disperse black 9, and the combination of these colorants. Those colorants are sometimes described as “disperse dyes” in Colour Index, Third Edition (Fourth Revision 1992), and may be suitable as disperse or sublimation colorants according to the present invention. Certain solvent dyes may also be used either alone, or in combination with disperse or sublimation colorants, such as Solvent Red 155.

Polymeric or synthetic materials such as polyester, modified polyester of either aliphatic or aromatic, and either straight chain or branched polyamides and modified polyamides, polyurethane, polyester polyurethane, polycarbonate and the like may be used where an affinity of the polymeric or synthetic material to disperse or sublimation colorants presents upon heat activation or sublimation process. Reactive polymeric or synthetic materials of these materials are especially desirable due to their crosslinking capability and affinity towards disperse or sublimation colorants. Reactive functional groups of these polymeric materials participate in the crosslinking reaction with both reactive colorants, such as reactive dyes, acid dyes, basic dyes, vat dyes, and/or grafted reactive pigments, and functional groups from the final printing substrate. Substantially decreased surface fibrillation is achieved, and improved image fastness and permanence results. The affinity of disperse dyes or sublimation dyes to the polymeric materials improves color intensity and visual appearance. Examples of such materials include polyester polyol, such as polyethylene adipate (PEA), polytetramethylene adipate (PTMA), polycaprolactone (PCL), caprolacone polyester polyol (e.g. CAPA 2043, 2054, 3031, 3022, 3050, 3091, 4101 from Brian-Jones of United Kingdom), polyester polyamine, polyamide, unsaturated polyester, polymer with aminoester or hydroxyl aminoester functional groups or pendants, ethylene vinyl acetate (EVA) homopolymer or copolymer, reactive polyurethane, self-crosslinking polyurethane, hybrid polyurethane such as acrylic or polyacrylic polyurethane, acetoacetoxy (AcAc) functional polymers or resins such as acetoacetoxyethyl acrylate (MEA) and acetoacetoxyethyl methacrylate (AAEM). Water-soluble/water-reducible, and solvent-soluble, or solvent-less plasticizer polymeric materials may be used. Solution, emulsion or microemusion/macroemulsion, natural or synthetic polymerized latex, colloidal, or sol-gel system comprising these polymers may also be used for the desired ink or toner. Preferably, the molecular weight of the polymeric or resinous material with affinity toward disperse or sublimation colorants is from 3,000 to 500,000 and with glass transition temperature (Tg) of no higher than 220° C. Most preferably, a molecular weight from 5,000 to 100,000 and a glass transition temperature (Tg) of no higher than 60° C. may be used.

The disperse or sublimation colorants may be activated by heat or by radiation. Depending on the activation or sublimation energy level required by a colorant, the ink may be activated at a temperature from 100 to 240° C. However, a pre-conditioned polymer/colorant ink may substantially decrease the energy level for activation.

The inks may comprise a binder component. Typically, the ink binder is the “glue” that holds the ink onto the substrate. Binders can be a single resin or a complex combination of resins, plasticizers, and other additives. Binders impact the viscosity of the system and promote droplet formation. The binder also serves to adhere the colorant to the surface of the substrate, control the gloss of the colorant, control the definition of the print of the colorant, and determine the alkali solubility of the ink, among other purposes. The binders are preferred to be film forming, amorphous, low odor, colorless or pale, transparent. The binders are either soluble or form a stable emulsion or colloid in the carrier system where surfactants, emulsifiers, humectants and/or co-solvents may be used in the ink. Either structured or random polymers may be selected for use as ink binders. Structured polymers have a block, branched, or graft structure.

Aqueous ink formulations contain water as the majority ink carrier. Therefore, binders used in aqueous ink formulations should be water soluble, dispersible or emulsifiable polymers and copolymers. Examples of such binders include phenolics; acrylics such as poly(meth)acrylic acid and salts, polyacrylamide, polystyrene-acrylates; vinyl resins such as polyvinyl alcohol, polyvinyl acetate, and polyvinyl butyral; polyalkyleneoxides such as polyethylene oxide and polyethylene glycol; polyamides; polyamines such as polyvinylpyridine, polyvinylpyrrolidone, polyvinylamine, and polyethyleneimine; cellulose derivatives such as nitrocellulose, ethyl cellulose, ethyl hydroxyethyl cellulose, cellulose acetate butyrate, cellulose acetate propionate, and sodium carboxymethyl cellulose.

Other aqueous ink additives such as water miscible humectants, co-solvents, wetting agents, emulsifiers, solubilizers, charging agents, and dispersants may be used to assist in creating a stable emulsion or colloid of hydrophobic components in the ink suitable for either of the previous mentioned printing systems. Co-solvents may serve several functions. They act as humectants, i.e. they help minimize the evaporation of water and prevent crystallization of the dye/pigment inside the ink jet nozzle. Co-solvents may further help control viscosity and the surface tension of the inks, two very important parameters. Co-solvents that may be used in this invention include but are not limited to N-methyl pyrrolidone/pyrrolidinone and glycols, particularly ethylene glycol such as LEG-1 and LEG-7 (both by Lipo Chemicals), diethylene glycol, propylene glycol, etc., as well as the ethers of such glycols, particularly mono-alkyl ethers. Straight-chain ethers may be more effective viscosity-reducing agents than branched chain isomers, and their efficiency may increase with an increasing number of carbon atoms in the alkoxy groups.

Correctly selected co-solvents may improve the solubility of certain colorants. Furthermore, the use of co-solvents with relatively lower boiling temperature than water may also help improve the stability of the emulsion ink system for thermal or bubble-jet inkjet system. Such co-solvents enable the quick formation of vaporized bubbles, thereby preventing the breakdown of emulsion particles by the heat from the heating elements, while aiding in inhibiting blocked ingredients in the ink from being unblocked by exposure to heat during the printing process. Examples of such co-solvents include 1-methoxy-2-propanol, iso-propanol, and iso-butyl vinyl ether.

Wetting agents may include such compounds as fatty acid alkanolamides, oxyethylene adducts from fatty alcohols or fatty amines. Other surface tension modifiers and/or interfacial modifiers include but not limited to di-, triethanolamine, amine oxide, sulfonated alkyl/fatty ester, aromatic/alkyl phosphate ester.

Common aqueous-based dye/pigment dispersants include such compounds as lignin sulfonates, fatty alcohol polyglycol ethers, and aromatic sulfonic acids, for instance naphthalene sulfonic acids. Some dispersants are polymeric acids or bases which act as electrolytes in aqueous solution in the presence of the proper counter ions. Such polyelectrolytes may provide electrostatic as well as steric stabilization of dispersed particles in the emulsion. Furthermore, they supply the ink with charging characteristics, if required by the printer application. Examples of polyacids include polysaccharides such as polyalginic acid and sodium carboxymethyl cellulose; polyacrylates such as polyacrylic acid, styrene-acrylate copolymers; polysulfonates such as polyvinylsulfonic acid, styrene-sulfonate copolymers; polyphosphates such as polymetaphosphoric acid; polydibasic acids (or hydrolyzed anhydrides), such as styrene-maleic acid copolymers; polytribasic acids such as acrylic acid-maleic acid copolymers. Examples of polybases include polyamines such as polyvinylamine, polyethyleneimine, poly(4-vinylpyridine); polyquaternary ammonium salts such as poly(4-vinyl-N-dodecyl pyridinium). Amphoteric polyelectrolytes may be obtained by the copolymerization of suitable acidic and basic monomers, for instance, methacrylic acid and vinyl pyridine.

Aqueous ink also contains pH modifiers; anti-foaming chemicals such as silicone oil emulsions; fusion control agents; corrosion inhibitors; fungicides; antifreeze agents, such as ethylene glycol, propylene glycol, glycerol or sorbitol; antioxidants; and UV-light stabilizers.

The aqueous ink additives may contain reactive functional groups to improve water resistance of the final image, since such additives are hydrophilic substances.

For non-aqueous ink formulations, the carrier may be based on organic solvents, such as hydrocarbon, alcohol, glycol ethers, glycol esters, ketone, or ester solvents. Alternately, the carrier may be based on natural or synthetic drying or nondrying oils. Binders used in such inks must be soluble or emulsifiable in these carriers. The ink binder may include resins, plasticizers, and waxes. Typical resins include phenolic resins, rosin modified phenolic resins, alkyd resins, hydrocarbon resins, polystyrene resins and copolymers, terpene resins, silicone resins, alkylated urea formaldehyde resins, alkylated melamine formaldehyde resins, polyamide and polyimide resins, chlorinated rubber and cyclized rubber, vinyl resins, ketone resins, acrylic resins, epoxide resins, polyurethane resins, and cellulose derivative resins. Other additives include surfactants, dispersants, antioxidants, light stabilizers, and drying oil catalysts.

For phase change, or hot melt, ink formulations, hot-melt carriers are used with combinations of hot-melt resins, wax or wax-like materials, tackifying agents, and plasticizers. These materials are solid in form at room temperature but become liquid at the temperature the printer operates, which is generally from 50 to 150 degrees C. Examples of phase change ink carriers include paraffins, microcrystalline waxes, polyethylene waxes, ester waxes, fatty acids, fatty alcohols, fatty amides (usually a mono-amide wax and a tetra-amide resin), sulfonamide materials, resinous materials made from different natural sources (tall oil rosins and rosin esters) and many synthetic resins, oligomers, polymers and co-polymers. A preferred tetra-amide resin is a dimer acid based tetra-amide that is the reaction product of dimer acid, ethylene diamine, and stearic acid. A preferred tackifier resin is a glycerol ester of hydrogenated abietic acid. Other additives may include binders, viscosity modifiers, light stabilizers, anti-oxidants and the like.

Viscosity control of liquid inks allows the ink to print through an inkjet printing device. The viscosity value of the ink may be, for commonly applied ink jet printers, in the range of 1-50 cps, and preferably within a range of 3-20 cps. Ink that is too viscous may result in printing difficulties, poor droplet size or shape forming and control, and/or damaged print orifices.

Surfactants may be used in the processes of wetting, emulsification, solubilization, ink drop forming and surface energy control or modification. Surfactants used for creating oil-in-water type emulsion may include anionic, cationic, nonionic and amphoteric surfactants with various molecular weight values. Surfactants used for non-aqueous based emulsion ink system are preferably the non-ionic type. Depending on the specific HLB (Hydrophilic Lipophilic Balance) values, some surfactants may also be called emulsifiers or emulsifying agents. High HLB value surfactants are generally used for emulsifying oil-in-water or aqueous type of systems, whereas low HLB value surfactants may generally be used to create water-in-oil or non-aqueous type of emulsion systems. Reactive surfactants may also be used. The reactive surfactants include hydroxyl, carboxylic, amine, amidal-terminated copolymeric surfactants.

When the surfactant/emulsifier concentration in a liquid carrier exceeds its critical micelle concentration (CMC), the molecules of the surfactant/emulsifier begin to aggregate. Aggregation of surfactants/emulsifier along with other ingredients forms micelles or reverse micelles, depending the main carrier phase is aqueous or non-aqueous, with a typical structure of non-soluble ingredient particles or aggregates surrounded by surfactant/emulsifier molecule layer. A homogenous, but multi-phase, system is therefore generated with small but isolated droplets of micelle carrying colorants, binders, miscible or non-miscible co-solvents and/or humectants, additives, etc. inside the micelle structure and suspending in the major carrier phase to prevent further aggregation or phase separation. These micelle particles are small enough in size to create a free flow liquid applicable in inkjet printing without clogging printing mechanism, and also protect the ingredients, especially the heat-sensitive materials inside the micelle particles having a direct contact with each other, and/or having a direct contact with printing mechanisms such as a heating element in thermal or bubble-jet inkjet printing. The non-soluble, non-miscible ingredients used in the application therefore can be stabilized with useable concentration.

In order to create a stable emulsion, micro/macroemulsion, colloidal, or a sol-gel ink system, surfactant/emulsifier may be used. Multiple surfactants/emulsifiers may also be used with combination to further enhance the protection, stability, flow characteristics, and printing performance, so long as such material does not have any negative impact on the reactive ingredients during the storage and image generating processes. Furthermore, depending on the CMC value, HLB value, and/or other characteristics of the surfactant/emulsifier, different concentration can be used in obtain best performance of the ink system corresponding to a specific printing mechanism.

Examples of surfactants and emulsifiers include alkylaryl polyether alcohol nonionic surfactants, such as Triton X series (Octylphenoxy-polyethoxyethanol); alkylamine ethoxylates nonionic surfactants such as Triton FW series, Triton CF-10, and Tergitol (Union Carbide Chemicals); polysorbate products such as Tween (ICI Chemicals and Polymers); polyalkylene and polyalkylene modified surfactants, such as Silwet surfactants (polydimethylsioxane copolymers) and CoatOSil surfactants from OSI Specialties; alcohol alkoxylates nonionic surfactants, such as Renex, BRIJ, and Ukanil; Sorbitan ester products such as Span and Arlacel; alkoxylated esters/PEG products, such as Tween, Atlas, Myrj and Cirrasol surfactants from ICI Chemicals and Polymers; unsaturated alcohol products such as surfynol series surfactants from Air Products Co., alkyl phosphoric acid ester surfactant products, such as amyl acid phosphate, Chemphos TR-421; alkyl amine oxide such as Chemoxide series from Chemron Corporation; anionic sarcosinate surfactants such as Hamposyl series from Hampshire Chemical corporation; glycerol esters or polyglycol ester nonionic surfactants such Hodag series from Calgene Chemical, Alphenate (Henkel-Nopco), Solegal W (Hoechst AG), Emultex (Auschem SpA); and polyethylene glycol ether surfactants such as Newkalgen from Takemoto Oil and Fat. Co. and other commercial surfactants known to the skilled in the art.

In addition to creating a stable emulsion or colloid ink system, surfactants are also used for surface energy or surface tension control. In either aqueous or non-aqueous case, the surface tension of the final ink should range from 20 dyne/cm to 55 dyne/cm and preferably from 35 dyne/cm to 45 dyne/cm.

The final transfer substrate may include plastics, metals, wood, glass, ceramics, paper, or textile materials. Preferred are textile materials including such materials as cotton, secondary cellulose acetate, rayon, wool, silk, and polyamides such as nylon 6, nylon 66 or nylon 12. The substrates must be able to withstand the heat transfer temperature without deforming, melting or degrading.

In certain aspects, the chevron-shaped brush 105 provides a safe alternative to rotating parts (i.e., rollers) to stretch the textile substrate 102 across the ink transfer substrate 103 before reaching the heating element 104. A person performing the method risks little possibility of injury with the chevron-shaped brush 105 whereas rotating parts can easily catch and injure fingers as the textile substrate 102 and ink transfer substrate 103 are fed towards the heating element 104.

While the disclosure has been described in connection with specific embodiments thereof, it will be understood that it is capable of further modifications and this application is intended to cover any variations, uses, or adaptations of the disclosure following, in general, the principles of the disclosure and including such departures from the present disclosure as come within known or customary practice within the art to which the disclosure pertains and as may be applied to the essential features hereinbefore set forth and as follows in the scope of the appended claims.

We claim:

1. An apparatus for transferring an image onto a textile substrate using dye sublimation, the apparatus comprising:
a flat support structure on which the textile substrate is laid with an ink transfer substrate;
a heating element that rotates and applies heat while pulling the textile substrate and ink transfer substrate from the flat support structure towards the heating element; and
a chevron-shaped brush with the vertex of the chevron pointing away from the heating element wherein the textile substrate and ink transfer substrate pass under the chevron-shaped brush before contacting the heat element.

2. The apparatus according to claim 1, wherein the textile substrate is a stretch fabric.

3. The apparatus according to claim 2, wherein the stretch fabric is a material selected from the group consisting of nylon, rayon, cotton, secondary cellulose acetate, wool, silk, polyamides, and combinations thereof.

4. The apparatus according to claim 1, wherein the textile substrate is brushed and/or napped.

5. The apparatus according to claim 1, wherein the textile substrate is knitted or woven.

6. The apparatus according to claim 1, wherein the chevron-shaped brush comprises bristles made of a synthetic material that provide the bristles with the flexibility to stretch the textile substrate without tearing or damaging the textile substrate.

7. The apparatus according to claim 6, wherein the synthetic material is selected from the group consisting of a low-density polyethylene (LDPE), a polypropylene, a polyamide (PA), and a polyester.

8. The apparatus according to claim 7, wherein the PA is selected from the group consisting of PA-6, PA-66, PA-610 and PA-612.

9. The apparatus according to claim 7, wherein the polyester is polybutylene terephthalate (PBT).

10. A method for transferring an image onto a textile substrate using dye sublimation, the method comprising:
a) placing an ink transfer substrate on a flat support structure;
b) spreading a textile substrate on top of the ink transfer substrate;
c) feeding the ink transfer substrate and textile substrate under a chevron-shaped brush into a heating element that rotates and applies heat while pulling the textile substrate and ink transfer substrate from the flat support structure towards the heating element; and
d) applying heat and pressure to the ink transfer substrate and textile substrate with the heating element to induce dye sublimation,
wherein the vertex of the chevron points away from the heating element and the textile substrate and ink transfer substrate pass under the chevron-shaped brush before contacting the heat element.

11. The method according to claim 10, wherein the chevron-shaped brush stretches the textile substrate across the ink transfer substrate to prevent irregularities in the surface of the textile substrate during the dye sublimation.

12. The method according to claim 11, wherein the irregularities are wrinkles and/or folds in the surface of the textile substrate.

13. The method according to claim 10, wherein the textile substrate is a stretch fabric comprising a material selected from the group consisting of nylon, rayon, cotton, secondary cellulose acetate, wool, silk, polyamides, and combinations thereof.

14. The method according to claim 10, wherein the textile substrate is brushed and/or napped.

15. The method according to claim 10, wherein the textile substrate is knitted or woven.

16. The method according to claim 10, wherein the chevron-shaped brush comprises bristles made of a synthetic material that provide the bristles with the flexibility to stretch the textile substrate without tearing or damaging the textile substrate.

17. The method according to claim 16, wherein the synthetic material is selected from the group consisting of a low-density polyethylene (LDPE), a polypropylene, a polyamide (PA), and a polyester.

18. The method according to claim 17, wherein the PA is selected from the group consisting of PA-6, PA-66, PA-610 and PA-612.

19. The method according to claim 17, wherein the polyester is polybutylene terephthalate (PBT).
